(19) United States
(12) Patent Application Publication
(10) Pub. No.: US 2014/0060431 A1
(43) Pub. Date: Mar. 6, 2014

(54) Atomic Layer Deposition System with Multiple Flows

(71) Applicant: St. John's University, New Taipei City (TW)

(72) Inventors: Rwei-Ching Chang, New Taipei City (TW); Tsai-Cheng Li, New Taipei City (TW); Chen-Pei Yeh, New Taipei City (TW); Hsi-Ting Hou, New Taipei City (TW); Te-Feng Wang, New Taipei City (TW); Fa-Ta Tsai, New Taipei City (TW)

(21) Appl. No.: 13/937,276

(22) Filed: Jul. 9, 2013

(30) Foreign Application Priority Data
Aug. 28, 2012 (TW) 101131292

(51) Int. Cl. B05C 5/00

(52) U.S. Cl. CPC B05C 5/00
USPC 118/712

(57) ABSTRACT

An atomic layer deposition system with multiple flows comprises: a square vacuum chamber, which internally has four pairs of intakes and vents to control the flowing in-and-out of precursors and improve the quality of coating and the coating uniformity of an asymmetrical testing member; plural gas detection sensors, which monitor the states of the exhausting of the precursors in the chamber and automatically controls and alarms for the amount of the induction of the precursors to prevent the obstruction of the vents; and a discrete pyramidal cover, which has a precursor intake in the top of the cover, the pipelines of the induction of the precursors and the pipelines of the four pairs of the intakes and the vents are integrated in order to cooperate with the cover while coating a three-dimensional element, a vertical flow field of the precursors is then produced from top to bottom in the cover.

### BACKGROUND OF THE INVENTION

1. Field of the Invention

The present invention generally relates to an atomic layer deposition system, more particularly to an atomic layer deposition system that has the functions of multiple flows and three-dimensional coating.

2. Description of the Related Art

With the development of semiconductors and panel industry, atomic layer deposition (ALD) thin film technology has made rapid progress in response to the needs of industry and then has developed a number of domestic atomic layer deposition systems. Such that, many products have become more and more internationally competitive. Although, for the development of the atomic layer deposition of thin film technology, there are still many bottlenecks to be broken through, especially the vacuum technology, it still needs to invest more research and development. Because of the industry cluster effect, the atomic layer deposition system may be highly developed have the opportunity to become a major precision equipment industry.

As shown in FIG. 1, which illustrates a horizontal atomic layer deposition system. the chamber has an intake 1 and a vent 2. The intake 1 is located above the chamber mainly providing the precursors and high purity nitrogen purge. The vent 2 is under the chamber and is mainly responsible to remove excess precursors. While the precursors enters from the intake and the specimen is proceeded by chemisorption, the excess precursors are discharged by the vent 2, and then high purity nitrogen is sprayed into the chamber via the intake 1 for purging the chamber, and then a next reaction is continued, thus such procedures are continuously repeated in order to achieve better effect of coating.

According to experimental results, although the horizontal atomic layer deposition system achieves a good coating quality, but there is only one intake and one vent to form a single-directional flow field, as shown in FIG. 2. As a matter of fact, the coating uniformity of the single-directional flow field is still a slight difference, especially for the asymmetric object, the difference is more obvious, and the single-directional flow field is not suitable for coating three-dimensional object. More, single vent may cause too many precursors due to careless operations. Thus, the extracted precursors reacting with the coating film of an exhausting valve, so as to cause the obstruction of the valve. Therefore, if we can change the configuration of pipeline and modify the chamber structure to form a multi-directional flow design and have a three-dimensional coating function, it will significantly enhance the abilities of coating an asymmetric object and a three-dimensional object.

The prior art, which publication number is 201002854 and is called APPARATUS AND METHOD FOR HIGH-THROUGHPUT ATOMIC LAYER DEPOSITION, and another prior art, which issuing number is 540093 and is called ATOMIC LAYER DEPOSITION SYSTEM AND METHOD THEREOF, adopt the coatings of the flow fields of one intake with one vent and multiple intakes with one vent. Therefore, how to design an atomic layer deposition system with multiple flows is an important issue for the skilled persons in the art.

### SUMMARY OF THE INVENTION

The main object of the present invention is to provide an atomic layer deposition system so as to reach the purposes of multiple flows and three-dimensional coating. A pair of intake and vent is equipped around each of the four corners of the square vacuum chamber, and a gas detection sensor is installed around each pair of intake and vent. The quality of deposition of atomic layer is improved, and the state of exhausting of precursors is monitored in order to reach a good quality of coating and prevent the obstruction of the vents and save materials. Further, a discrete pyramidal cover 7 is provided by the present invention. A precursor intake is installed in the top of the discrete pyramidal cover, the pipelines of the induction of the precursors and the pipelines of the four pairs of the intakes and the vents are integrated in order to cooperate with the discrete pyramidal cover while coating a three-dimensional element, then a vertical flow field of the precursors is then produced from top to bottom in the discrete pyramidal cover. The present invention promotes stability, convenience, practicality, and added values, and has:

(1) a square vacuum chamber, which internally has four pairs of intakes and vents around the four corners of the square vacuum chamber respectively, in order to control the flowing in-and-out of precursors and improve the quality of coating and the coating uniformity of an asymmetrical testing member;

(2) a plurality of gas detection sensors, which are installed around each pair of intake and vent monitors the states of the exhausting of the precursors in the square vacuum chamber and automatically controls and alarms for the amount of the induction of the precursors in order to prevent the waste of the precursors and the obstruction of the vents;

(3) a discrete pyramidal cover, which has a precursor intake in the top of the discrete pyramidal cover, the pipelines of the induction of the precursors and the pipelines of the four pairs of the intakes and the vents being integrated in order to cooperate with the discrete pyramidal cover while coating a three-dimensional element, a vertical flow field of the precursors being then produced from top to bottom in the discrete pyramidal cover.

According to the present invention, the present invention changes a horizontal atomic layer deposition system to an improved atomic layer deposition system integrated with the functions of controlling multi-directional flow, automatically adjusting the amount of precursors and vertical coating so as to promote added values. The present invention mainly approaches following objectives listed below:

(1) multi-directional flow atomic layer deposition: the induction and exhausting of the multiple flows of the precursors is capable of improving the quality of coating of an atomic layer deposition system and the coating uniformity of an asymmetrical testing member. The operations for the system is convenient for general manufacturers or small labs.

(2) reducing the waste of the precursors: four gas detection sensors equipped around the four pairs of intakes and vents monitor the states of the exhausting of the precursors and automatically controls and alarms for the amount of the induction of the precursors in order to prevent the waste of the precursors and the obstruction of the vents.

(3) vertical atomic layer deposition: discrete pyramidal cover is easily changed and installed. Thus, the pipelines of the induction of the precursors and the pipelines of the four pairs of the intakes and the vents are integrated in order to cooperate with the discrete pyramidal cover while coating a three-dimensional element, a vertical flow field of the precursors is then produced from top to bottom in the discrete pyramidal cover, so as to finish the coating of a three-dimensional element. As it can be seen, the present invention is capable of promoting stability, convenience, practicality, and added values.

Other and further features, advantages, and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of the horizontal atomic layer deposition system of prior arts;

FIG. 2 illustrates a schematic view of a single flow of prior arts;

FIG. 3 illustrates a schematic view of a first preferred embodiment of the atomic layer deposition system with multiple flows of the present invention;

FIG. 4 illustrates a schematic view of a control panel of the first preferred embodiment of the atomic layer deposition system with multiple flows of the present invention;

FIG. 5 illustrates a schematic view of a vacuum chamber of the first preferred embodiment of the atomic layer deposition system with multiple flows of the present invention;

FIG. 6 illustrates a schematic view of a discrete pyramidal cover of the second preferred embodiment of the atomic layer deposition system with multiple flows of the present invention;

FIG. 7 illustrates a schematic view of a precursor flow field of upper-left coming and lower-right going of the second preferred embodiment of the atomic layer deposition system with multiple flows of the present invention;

FIG. 8 illustrates a schematic view of a precursor flow field of upper-right coming and lower-left going of the second preferred embodiment of the atomic layer deposition system with multiple flows of the present invention;

FIG. 9 illustrates a schematic view of a precursor flow field of lower-right coming and upper-left going of the second preferred embodiment of the atomic layer deposition system with multiple flows of the present invention;

FIG. 10 illustrates a schematic view of a precursor flow field of lower-left coming and upper-right going of the second preferred embodiment of the atomic layer deposition system with multiple flows of the present invention;

FIG. 11 illustrates a schematic transparent view of a discrete pyramidal cover of the second preferred embodiment of the atomic layer deposition system with multiple flows of the present invention; and

FIG. 12 illustrates a schematic transparent view of a vertical flow field of the second preferred embodiment of the atomic layer deposition system with multiple flows of the present invention.

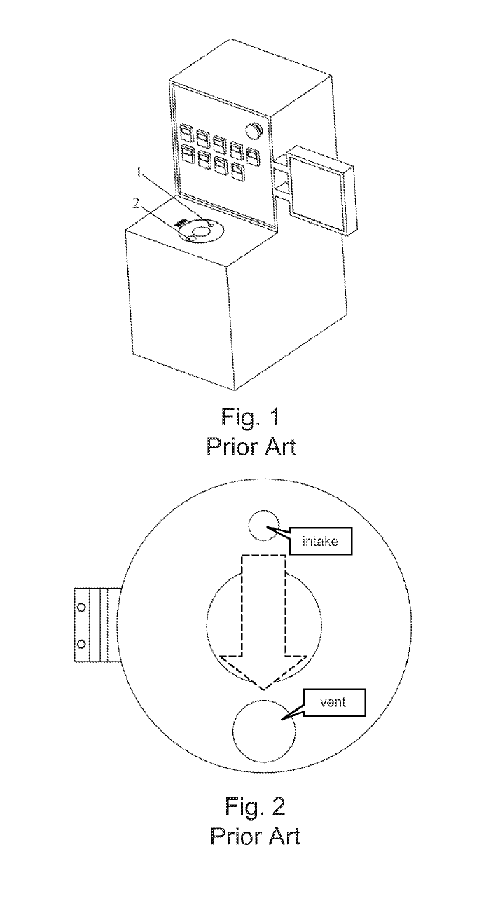

### DETAILED DESCRIPTION OF THE INVENTION Following preferred embodiments and figures will be described in detail so as to achieve aforesaid objects.

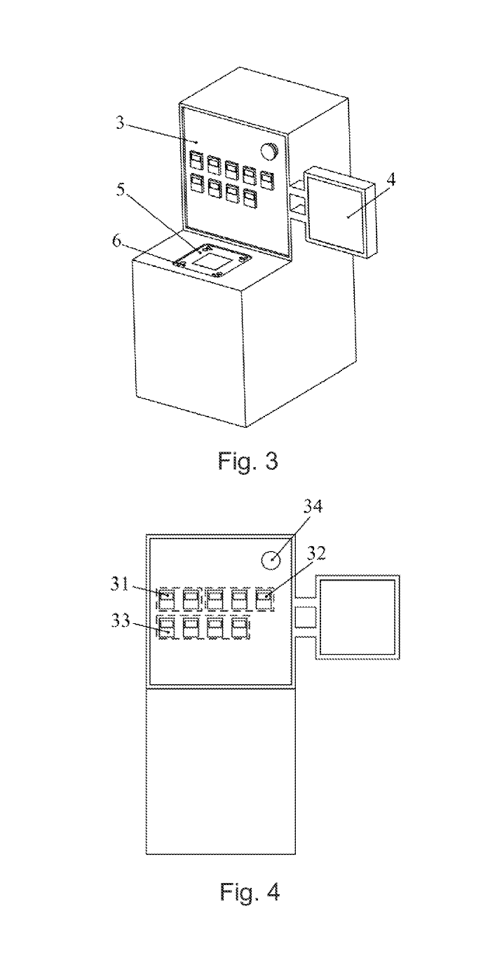

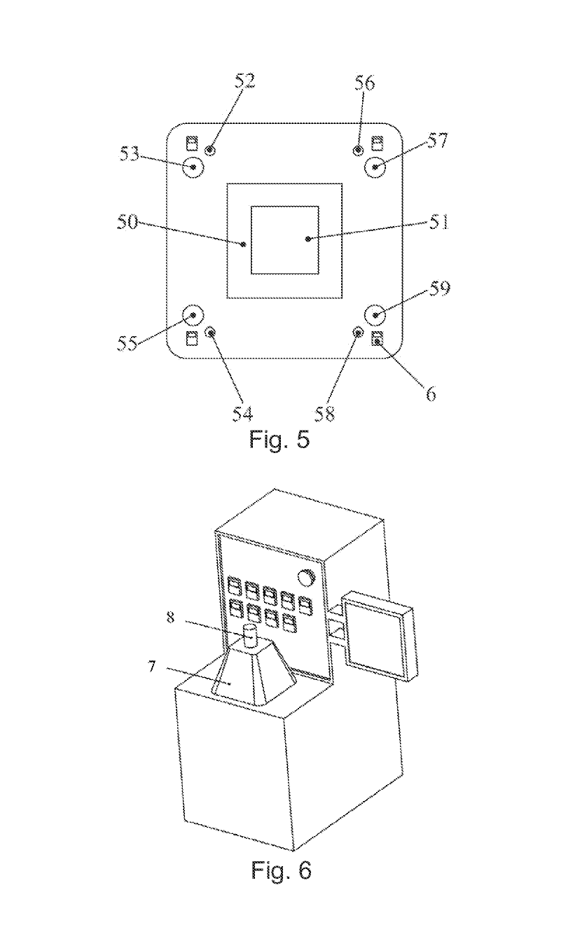

With reference to FIG. 3, which illustrates a schematic view of a first preferred embodiment of the atomic layer deposition system with multiple flows of the present invention. The atomic layer deposition system with multiple flows has: a control panel 3, which has a chamber temperature controller 31, a pipeline temperature controller 32, a precursor controller 33, and an emergency button 34, as shown in FIG. 4; an atomic layer deposition system control panel 4; a square vacuum chamber 5, which has a carrier 50 in order to dispose a specimen 51; four pairs of intakes and vents, which are one pair of an upper-left intake 52 and an upper-left vent 53, one pair of a lower-left intake 54 and a lower-left vent 55, one pair of an upper-right intake 56 and an upper-right vent 57, and one pair of a lower-right intake 58 and a lower-right vent 59 and are used to the multi-directional induction and the multi-directional exhausting of precursors; and a plurality of gas detection sensors (6), which monitors the states of the exhausting of the precursors, as shown in FIG. 5.

With reference to FIG. 6, which illustrates a schematic view of a second preferred embodiment of the atomic layer deposition system with multiple flows of the present invention. The second preferred embodiment is equipped with an additional discrete pyramidal cover 7, which has a precursor intake 8 in the top of the discrete pyramidal cover 7, the pipelines of the induction of the precursors and the pipelines of the four pairs of the intakes 1 and the vents 2 being integrated in order to cooperate with the discrete pyramidal cover 7 while coating a three-dimensional element, a vertical flow field of the precursors is then produced from top to bottom in the discrete pyramidal cover 7.

Following will describe the steps of the multiple flow directions of the precursors, and the steps are that of:

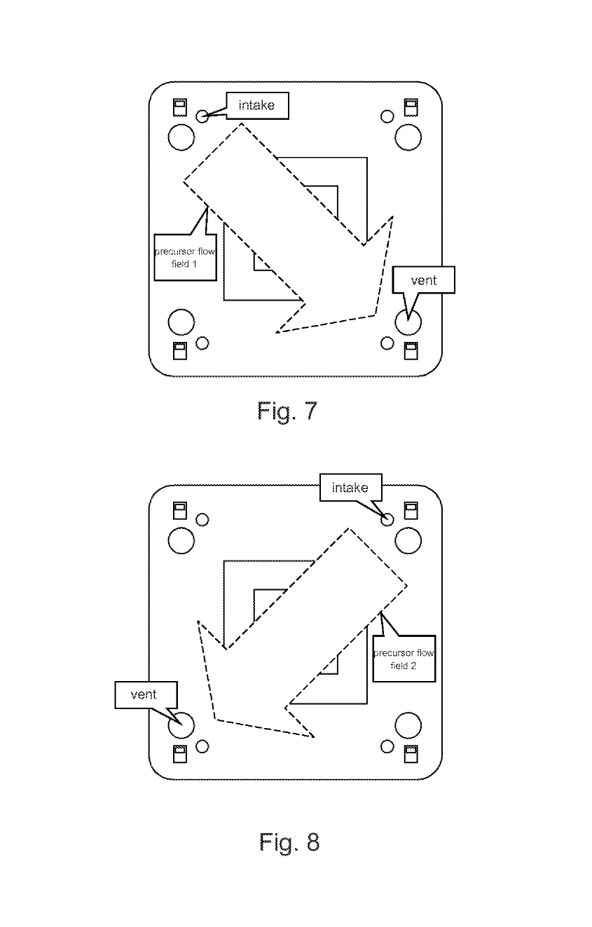

(S1) as shown in FIG. 7, disposing the specimen 51 on the carrier 50, inputting the precursors via the upper-left intake 52 in order to react the precursors with the specimen 51, excluding residue precursors out via the lower-right vent 59, hence a precursor flow field 1 of upper-left coming and lower-right going being generated;

(S2) as shown in FIG. 8, inputting the precursors via the upper-right intake 56 in order to react the precursors with the specimen 51, excluding the residue precursors out via the lower-left vent 55, hence a precursor flow field 2 of upper-right coming and lower-left going being generated;

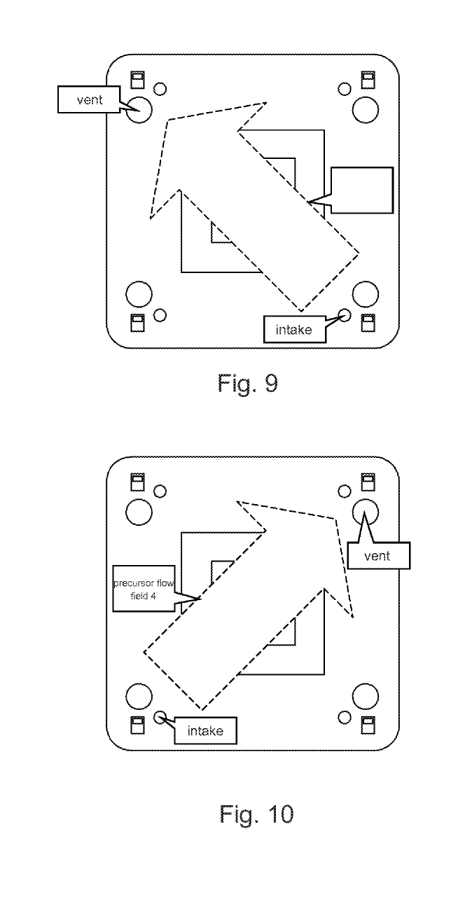

(S3) as shown in FIG. 9, inputting the precursors via the lower-right intake 58 in order to react the precursors with the specimen 51, excluding the residue precursors out via the upper-left vent 53, hence a precursor flow field 3 of lower-right coming and upper-left going being generated;

(S4) as shown in FIG. 10, inputting the precursors via the lower-left intake 54 in order to react the precursors with the specimen 51, excluding the residue precursors out via the upper-right vent 57, hence a precursor flow field 4 of lower-left coming and upper-right going being generated;

(S5) continuously proceeding the cycles of depositing atomic layers until that a demanded thickness is reached; and

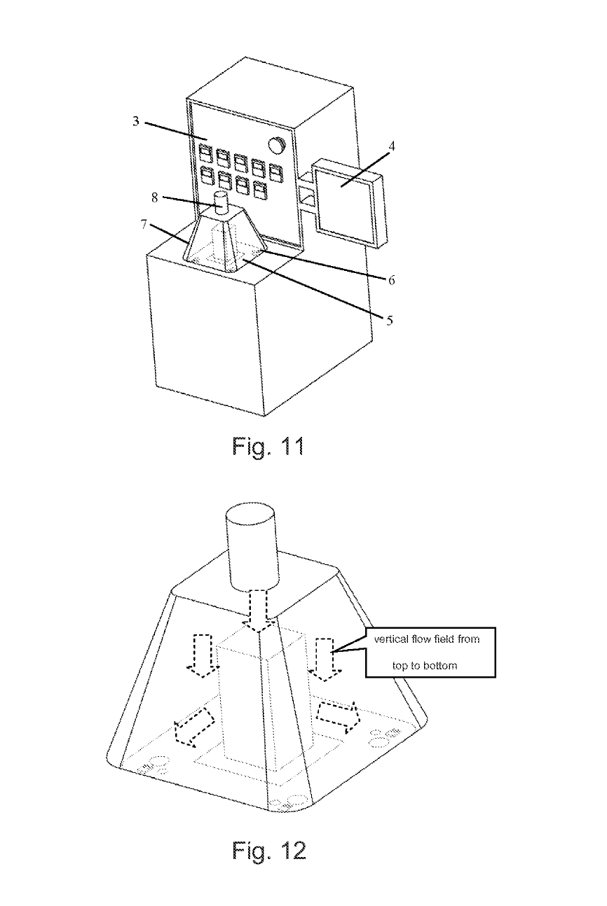

(S6) as shown in FIG. 11, the pipelines of the induction of the precursors and the pipelines of the plurality of pairs of the intakes 1 and the vents 2 being integrated in order to cooperate with the discrete pyramidal cover 7 while coating a three-dimensional element, a vertical flow field of the precursors being produced from top to bottom in the discrete pyramidal cover 7.

The present invention provides the functions of induction and exhausting of multiple directions of the precursors that improves the quality of coating of an atomic layer deposition system and the coating uniformity of an asymmetrical testing member. The operations for the system is convenient for general manufacturers or small labs.

Further, the precursor intake 8 is in the top of the discrete pyramidal cover 7, as shown in FIG. 6. The pipelines of the induction of the precursors and the pipelines of the four pairs of the intakes 1 and the vents 2 are integrated in order to cooperate with the discrete pyramidal cover 7 while coating a three-dimensional element, a vertical flow field of the precursors is then produced from top to bottom in the discrete pyramidal cover 7, as shown in FIG. 12. Hence, the present invention effectively promotes convenience, practicality and added values.

As a conclusion, the present invention is able to reach the purposes of multiple flow directions and three-dimensional coating. That is, a pair of intake and vent is added at each of the four corners of the square vacuum chamber 5. While the precursors enter into the square vacuum chamber 5 and react with the testing member, the precursor flow field 1, the precursor flow field 2, the precursor flow field 3, and the precursor flow field 4 are formed, as shown from FIG. 7 to FIG. 10. The functions of the multi-directional induction and exhausting of the precursors are able to improve the quality of the coating of the atomic layer deposition system and the coating uniformity of an asymmetrical testing member. The operations for the system is convenient for general manufacturers or small labs. More, four gas detection sensors 6 equipped around the four pairs of intakes and vents monitor the states of the exhausting of the precursors and automatically controls and alarms for the amount of the induction of the precursors in order to prevent the waste of the precursors and the obstruction of the vents 2.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. An atomic layer deposition system with multiple flows comprising:
a square vacuum chamber (5), which internally has four pairs of intakes (1) and vents (2) in order to control the flowing in-and-out of precursors and improve the quality of coating and the coating uniformity of an asymmetrical testing member;
a plurality of gas detection sensors (6), which monitor the states of the exhausting of the precursors in the square vacuum chamber (5) and automatically controls and alarms for the amount of the induction of the precursors in order to prevent the obstruction of the vents (2); and
a discrete pyramidal cover (7), which has a precursor intake (8) in the top of the discrete pyramidal cover (7), the pipelines of the induction of the precursors and the pipelines of the four pairs of the intakes (1) and the vents (2) being integrated in order to cooperate with the discrete pyramidal cover (7) while coating a three-dimensional element, a vertical flow field of the precursors being then produced from top to bottom in the discrete pyramidal cover (7).

2. The atomic layer deposition system with multiple flows according to claim 1, the amounts of the intake (1) and the vent (2) are variable with the demands of practical needs, the shape of the square vacuum chamber (5) is variable with the dispositions of the intake (1) and the vent (2).

3. An atomic layer deposition system with multiple flows comprising:
a square vacuum chamber (5), which internally has a plurality of pairs of intakes (1) and vents (2) in order to control the flowing in-and-out of precursors and improve the quality of coating and the coating uniformity of an asymmetrical testing member; and
a plurality of gas detection sensors (6), which monitor the states of the exhausting of the precursors in the square vacuum chamber (5) and automatically controls and alarms for the amount of the induction of the precursors in order to prevent the obstruction of the vents (2).

4. The atomic layer deposition system with multiple flows according to claim 3, the amounts of the intake (1) and the vent (2) are variable with the demands of practical needs, the shape of the square vacuum chamber (5) is variable with the dispositions of the intake (1) and the vent (2).

5. The atomic layer deposition system with multiple flows according to claim 3 further comprising a discrete pyramidal cover (7), which has a precursor intake (8) in the top of the discrete pyramidal cover (7), the pipelines of the induction of the precursors and the pipelines of the plurality of pairs of the intakes (1) and the vents (2) being integrated in order to cooperate with the discrete pyramidal cover (7) while coating a three-dimensional element, a vertical flow field of the precursors being produced from top to bottom in the discrete pyramidal cover (7).
